(19) United States
(12) Patent Application Publication
(10) Pub. No.: US 2007/0183295 A1
(43) Pub. Date: Aug. 9, 2007

(54) Optical pickup device

(75) Inventor: Kenji Nagashima, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/702,564

(22) Filed: Feb. 6, 2007

(30) Foreign Application Priority Data
Feb. 7, 2006 (JP) 2006-030170

(51) Int. Cl. G11B 7/00

(52) U.S. Cl. 369/112.07; 369/112.05

(57) ABSTRACT

An optical pickup device is equipped with a diffraction element that includes a transparent substrate. At least one surface of the transparent substrate is provided with a first region and a second region that encloses the first region. The surface is provided with a plurality of types of diffraction areas each of which generates predetermined diffracted light from only a light beam having a specific wavelength and permits other light beams having other wavelengths to pass through without diffraction. The first region is provided with each of the plurality of types of diffraction areas, while the second region is provided with only a diffraction area that generates the predetermined diffracted light from only a light beam having the maximum incident diameter among the plurality of types of diffraction areas.

This application is based on Japanese Patent Application No. 2006-030170 filed on Feb. 7, 2006, the contents of which are hereby incorporated by reference.

### BACKGROUND OF THE INVENTION

1. Field of the Invention

The present invention relates to an optical pickup device that projects a light beam to an optical recording medium so that information is recorded or reproduced. In particular, the present invention relates to a structure of a diffraction element disposed in an optical system of the optical pickup device so as to generate diffracted light.

2. Description of Related Art

At present, optical recording media including a compact disc (hereinafter referred to as a CD) and a digital versatile disc (hereinafter referred to as a DVD) are widely available. Furthermore, in order to increase a quantity of information recorded on the optical recording medium, researches on the high density of the optical recording medium are being carried on recently. For example, a high density optical recording medium such as a Blu-Ray Disk (hereinafter referred to as a BD) is being available in the market.

When such an optical recording medium is read or written, an optical pickup device is used for projecting a light beam to the optical recording medium so that information can be recorded or reproduced. Depending on a type of the optical recording medium, a numerical aperture (NA) of an objective lens as well as a wavelength of a light source has different values in the optical pickup device. Although, it is considered to use different optical pickup devices for different types of the optical recording media, it is more convenient to use a single optical pickup device that can write and read information on a plurality of types of optical recording media. Therefore, a lot of such optical pickup devices are developed.

A diffraction element for diffracting a light beam is disposed in the optical system of the optical pickup device for various purposes. For example, the diffraction element is disposed in the optical system so as to adjust a focal point of the light beam emitted from a light source on a recording surface of the optical recording medium constantly (i.e., focus control) and to make a position of a light beam spot follow a track formed on the optical recording medium (i.e., tracking control). In this structure of the optical pickup device, when the light beam passes through the diffraction element, predetermined diffracted light is generated. This predetermined diffracted light is used for generating a servo signal such as a focus servo signal and a tracking servo signal that are used for performing the focus control and the tracking control.

Since the optical pickup device is required to support a plurality of types of optical recording media as described above, the number of the diffraction elements provided to the optical pickup device increases corresponding to the number of optical recording media supported by the optical pickup device when the diffraction element is disposed for the purpose described above. Therefore, there will be a problem that the optical pickup device becomes large or the like. There is an optical pickup device disclosed in JP-A-2005-24656 or JP-A-2004-327005, which has a structure in which only one diffraction element is provided to the optical pickup device having a plurality of light sources of different wavelengths for supporting a plurality of types of optical recording media and an optical system with a diffraction element for obtaining a servo signal.

The optical pickup device disclosed in JP-A-2005-24656 or JP-A-2004-327005 has a following structure. The diffraction element is disposed in a common optical path for leading a plurality of light beams having different wavelengths to the optical recording medium, and ±1st order diffracted light that is generated when the light beam passes through the diffraction element is used for obtaining a tracking error signal. Then, the tracking control is performed by using the tracking error signal. Since the optical pickup device is required to support a plurality of light beams having different wavelengths with a single diffraction element, a diffraction element described in JP-A-2005-24656 has two types of diffraction gratings on one of two surfaces to which the light beam enters.

In addition, JP-A-2004-327005 describes not only the diffraction element having two types of diffraction gratings on one surface but also a diffraction element having two types of diffraction gratings on two surfaces, one type on one surface, and further a diffraction element having one type of diffraction grating on one surface and two types of diffraction gratings on the other opposite surface.

However, each of the diffraction elements provided to the optical pickup devices disclosed in JP-A-2005-24656 and JP-A-2004-327005 is aimed mainly at easiness in manufacturing the diffraction element. In addition, JP-A-2004-327005 merely discloses, concerning a method of arranging a plurality of types of different diffraction gratings, a structure for adjusting easily a division ratio between 0 order diffracted light (hereinafter also referred to as 0 order light) and 1st order diffracted light (hereinafter also referred to a ±1st order light) of the diffraction element and a structure for equalizing a light beam shape of the diffracted light to incident light. Therefore, it is insufficient in the following point for the optical pickup device that has a plurality of light sources emitting light beams of different wavelengths and a single diffraction element.

If a plurality of types of diffraction gratings are arranged on one surface of the diffraction element so as to support a plurality of light beams having different wavelengths by a single diffraction element, areas of diffraction gratings provided for diffracting light beams of different wavelengths becomes smaller than that in the case where only one type of diffraction grating is provided. Therefore, it becomes difficult to obtain sufficient light quantity of the diffracted light generated for each of the light beams of different wavelengths, i.e., sufficient quantity for light beams of all wavelengths. Concerning this point, the diffraction element disclosed in JP-A-2005-24656 or JP-A-2004-327005 cannot resolve this problem sufficiently.

### SUMMARY OF THE INVENTION

In view of the above described problem it is an object of the present invention to provide an optical pickup device that supports a plurality of types of optical recording media and is equipped with a single diffraction element for obtaining predetermined diffracted light of a plurality of light beams having different wavelengths, in which usage efficiency of light in the diffraction element can be improved.

To attain the above described object an optical pickup device in accordance with one aspect of the present invention includes: a plurality of light sources having different wavelengths; a condenser element for condensing a light beam emitted from the light source on a recording surface of the optical recording medium; a diffraction element disposed between the light source and the condenser element for diffracting an incident light beam, the diffraction element including a transparent substrate having two opposed surfaces and a diffraction grating formed on at least one of the two surfaces. And the optical pickup device is characterized by a structure in which the light beams entering the diffraction element have different incident diameters for different wavelengths, at least one of the two surfaces is provided with a first region and a second region, the second region is arranged to enclose the first region, the surface with the first and the second regions is provided with a plurality of types of diffraction areas each of which generates predetermined diffracted light from only the light beam having a specific wavelength and permits other light beams having other wavelengths to pass through without diffraction, each of the plurality of types of diffraction areas is disposed in the first region, and only a diffraction area that generates the predetermined diffracted light from the light beam having the maximum incident diameter among the plurality of types of diffraction areas is disposed in the second region.

Preferably, in the optical pickup device of the present invention having the structure described above, the first region is an region enclosed by a first circle having a diameter that is substantially the same as a diameter of a light beam other than the light beam having the maximum incident diameter among light beams that generate the predetermined diffracted light in the diffraction area, and the second region is an region enclosing the first circle and including a second circle substantially concentric with the first circle and the second circle having a diameter that is substantially the same as a diameter of a light beam having the maximum incident diameter among light beams that generate the predetermined diffracted light in the diffraction area.

More preferably, in the optical pickup device of the present invention having the structure described above, the plurality of types of diffraction areas include two types of diffraction areas, and in the first region each of the two types of diffraction areas is divided into a plurality of parts, which are arranged in a stripe manner so that different types of the diffraction areas are repeated alternately.

Still more preferably, in the optical pickup device of the present invention having the structure described above, the light sources include three light sources, the plurality of diffraction areas include two types of diffraction areas, and one of the two types of diffraction areas generates the predetermined diffracted light from only the light beam having the maximum incident diameter among light beams emitted from the light sources, while the other generates the predetermined diffracted light from only the light beam having the minimum incident diameter among light beams emitted from the light sources.

To attain the above described object an optical pickup device in accordance with one aspect of the present invention includes: three light sources having different wavelengths; a condenser element for condensing a light beam emitted from the light source on a recording surface of the optical recording medium; a diffraction element disposed between the light source and the condenser element for diffracting an incident light beam, the diffraction element including a transparent substrate having two opposed surfaces and a diffraction grating formed on at least one of the two surfaces. And the optical pickup device is characterized by a structure in which when the three light beams having different wavelengths emitted from the light sources are a first light beam, a second light beam and a third light beam in ascending order of an incident diameter entering the diffraction element from smaller one, one of the two surfaces is provided with a second diffraction area that generates predetermined diffracted light from only the second light beam and permits the first and the third light beams to pass through without diffraction, the other of the two surfaces is provided with a first region and a second region, the first region is an region enclosed by a first circle having a diameter that is substantially the same as the incident diameter of the first light beam, and the first region is provided with a first diffraction area that generates predetermined diffracted light from only the first light beam and permits the second and the third light beams to pass through without diffraction and a third diffraction area that generates predetermined diffracted light from only the third light beam and permits the first and the second light beams to pass through without diffraction, each of which is divided into a plurality of parts that are arranged in a stripe manner so that the first diffraction area and the third diffraction area repeat alternately, and the second region is an region enclosing the first circle and including a second circle substantially concentric with the first circle and the second circle having a diameter that is substantially the same as the incident diameter of the third light beam, and the second region is provided with only the third diffraction area.

According to first structure of the present invention, the optical pickup device, which is equipped with a single diffraction element that can obtain predetermined diffracted light from each of a plurality of light beams having different wavelengths, has a structure in which a part of the diffraction area is not disposed at unnecessary position when a plurality of types of diffraction areas are formed on one surface, by utilizing that diameters of light beams that pass through the diffraction element are different for different wavelengths of the light beams. Therefore, it is possible to obtain diffracted light effectively from each of the light beams having different wavelengths. As a result, usage efficiency of light in the diffraction element can be improved.

Moreover, according to the second structure of the present invention, usage efficiency of light in the diffraction element can be improved because the first region and the second region have the structure in which diffracted light can be obtained in the diffraction element effectively in the optical pickup device having the second structure.

Moreover, according to the third structure of the present invention, it is possible that the light beam entering the diffraction element can be distributed equally to the diffraction areas because the different types of diffraction areas are arranged alternately and repeatedly in a stripe manner in the region where two types of diffraction areas arranged when two types of diffraction areas are formed on one surface in the optical pickup device having the first or the second structure described above. Therefore, diffracted light with little deviation in its shape and quality can be obtained from the light beams having different wavelengths.

Moreover, according to the fourth structure of the present invention, it is possible to obtain appropriate quantity of light effectively for the diffracted light of light beams having different wavelengths because the combination of the light beams that generate predetermined diffracted light in the diffraction area is a combination of the light beams in which a difference of diameter between light beams entering the diffraction element becomes maximum when two types of diffraction areas are formed on one surface in the optical pickup device having any one of the first to the third structures described above.

Moreover, according to the fifth structure of the present invention, the optical pickup device, which is equipped with a single diffraction element that can obtain predetermined diffracted light from each of three light beams having different wavelengths, has a structure in which a part of the diffraction area is not disposed at unnecessary position when the two types of diffraction areas are formed on one surface, by utilizing that diameters of light beams that pass through the diffraction element are different for different wavelengths of the light beams. Therefore, it is possible to obtain diffracted light effectively from each of the light beams having different wavelengths, and usage efficiency of light in the diffraction element can be improved. In addition, since the combination of the light beams that generate predetermined diffracted light in the diffraction area is a combination of the light beams in which a difference of diameter between light beams entering the diffraction element becomes maximum when two types of diffraction areas are formed on one surface, it is possible to obtain appropriate quantity of light effectively for the diffracted light of light beams having different wavelengths. In addition, since different types of diffraction areas are repeated alternately in a stripe manner in the region where two types of diffraction areas are arranged when the two types of diffraction areas are formed on one surface, it is possible that the light beam entering the diffraction element can be distributed equally to the diffraction areas. Therefore, diffracted light with little deviation in its shape and quality can be obtained from the light beams having different wavelengths.

### BRIEF DESCRIPTION OF THE DRAWINGS

FIG. 1 is a schematic diagram to show a structure of an optical system in an optical pickup device according to the present embodiment.

FIG. 2 is a schematic diagram for explaining a function of an aperture limiting filter that is provided to the optical pickup device according to the present embodiment.

FIGS. 3A and 3B are schematic diagrams to show structures of diffraction elements provided to the optical pickup device according to the present embodiment.

FIG. 4 is a schematic diagram to show a first region and a second region of the diffraction element provided to the optical pickup device according to the present embodiment.

### DESCRIPTION OF THE PREFERRED EMBODIMENTS

Now, an embodiment of the present invention will be described with reference to the attached drawings. It should be noted that the embodiment described below is merely an example, and the present invention is not limited to the embodiment.

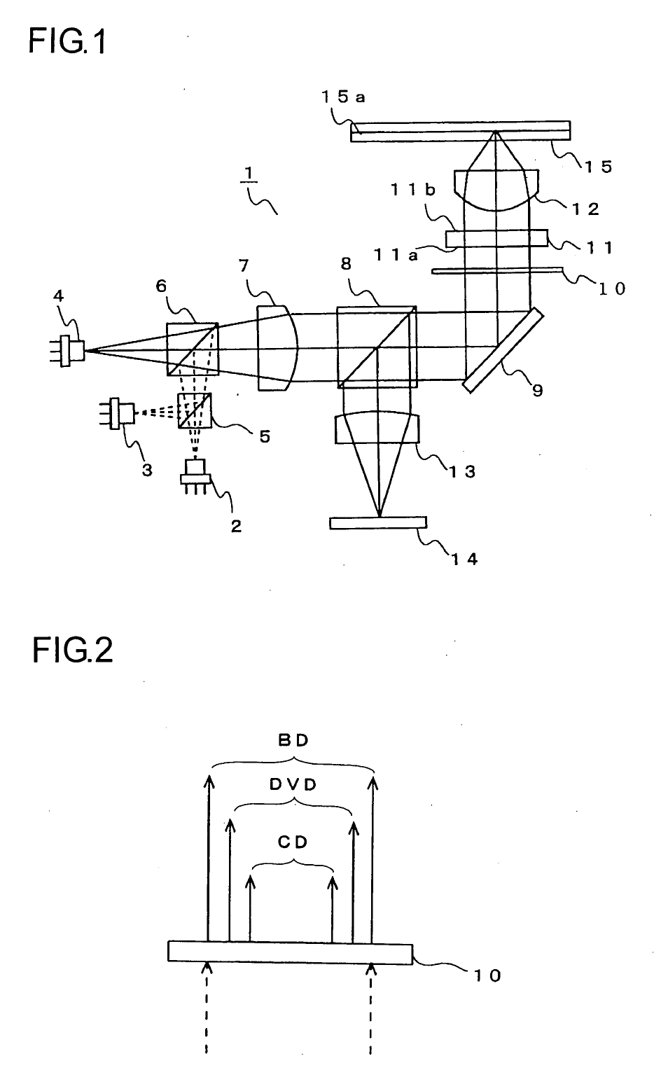

FIG. 1 is a schematic diagram to show a structure of an optical system in an optical pickup device according to the present embodiment. Numeral 1 denotes an optical pickup device that projects a light beam to one of three types of optical recording media 15 including a CD, a DVD and a BD and receives a reflection light for reading information recorded on a recording surface 15a of the optical recording medium 15 or projects a light beam to the optical recording medium 15 for recording information on the recording surface 15a. At this point the light beam shown by a solid line in FIG. 1 is one emitted from the third light source 4, and other light beams emitted from the other light sources 2 and 3 are not shown except for the part shown by a broken line.

The optical pickup device 1 is equipped with a first light source 2, a second light source 3, a third light source 4, a first dichroic prism 5, a second dichroic prism 6, a collimator lens 7, a beam splitter 8, an upstand mirror 9, an aperture limiting filter 10, a diffraction element 11, an objective lens 12, a detection lens 13, and a photo detector 14. Hereinafter, detail of each optical element will be described.

The first light source 2 is a semiconductor laser that emits a light beam of a 780 nm band supporting a CD, the second light source 3 is a semiconductor laser that emits a light beam of a 650 nm band supporting a DVD, and the third light source 4 is a semiconductor laser that emits a light beam of a 405 nm band supporting a BD. At this point the semiconductor lasers each of which emits only a light beam of a single wavelength are used as the light sources 2-4 in the present embodiment, but the present invention is not limited to this structure. For example, it is possible to use a two-wavelength combination semiconductor laser that can emit two types of light beams of two wavelengths for a CD and for a DVD in combination with a semiconductor laser that emits only a light beam of a single wavelength for a BD. Other modifications are possible in the scope of the present invention.

The first dichroic prism 5 permits a light beam emitted from the first light source 2 to pass through and reflects a light beam emitted from the second light source 3. Thus, optical axes of the light beams emitted from the first light source 2 and the second light source 3 match each other. The light beam that passed through the first dichroic prism 5 is sent to the second dichroic prism 6. The second dichroic prism 6 permits a light beam emitted from the third light source 4 to pass through and reflects the light beam sent from the first dichroic prism 5. Thus, optical axes of the light beams emitted from the first to the third light sources 2-4 match each other. The light beam that passed through the second dichroic prism 6 is sent to the collimator lens 7.

The collimator lens 7 converts the light beam that passed through the second dichroic prism 6 into parallel rays. The light beam that is made to be parallel rays by the collimator lens 7 is sent to the beam splitter 8.

The beam splitter 8 works as a light separation element for separating an incident light beam. It permits the light beam sent from the collimator lens 7 to pass through so as to be led to the optical recording medium 15, while it reflects the reflection light reflected by the optical recording medium 15 so as to be lead to the photo detector 14. The light beam that passed through the beam splitter 8 is sent to the upstand mirror 9.

The upstand mirror 9 reflects the light beam that passed through the beam splitter 8 and leads it to the optical recording medium 15. The upstand mirror 9 is tilted from the optical axis of the light beam from the beam splitter 8 by 45 degrees, so the light beam reflected by the upstand mirror 9 has an optical axis that is substantially perpendicular to the recording surface 15a of the optical recording medium 15. The light beam reflected by the upstand mirror 9 is sent to the aperture limiting filter 10.

The aperture limiting filter 10 is a diaphragm member that restricts the light beams having different wavelengths for different optical recording media to have predetermined effective diameters corresponding to a numerical aperture (NA) determined for each optical recording medium 15. It is adapted to have different ranges of permitting the light beams having different wavelengths to pass through the filter 10. FIG. 2 is a schematic diagram for explaining a function of the aperture limiting filter 10. As shown in FIG. 2, the aperture limiting filter 10 restricts the diameter of the light beam so that the effective diameter of the light beam is decreased in the order of the light beams for a BD, for a DVD and for a CD. Although the aperture limiting filter 10 that is made up of a resin plate or the like is disposed in the present embodiment, the present invention is not limited to this structure. For example, it is possible to dispose a so-called liquid crystal shutter or the like made up of liquid crystal. The light beam that passed through the aperture limiting filter 10 is sent to the diffraction element 11.

The diffraction element 11 diffracts the incident light beam so as to generate 0 order light and ±1st order light. In the optical pickup device 1 of the present embodiment, the diffracted light generated by diffracting the reflection light reflected by the optical recording medium 15 plays an important role. This diffraction element 11 has a structure in which both surfaces 11a and 11b of a transparent substrate are provided with diffraction gratings. The diffraction gratings are arranged so that the single diffraction element 11 can generate predetermined diffracted light for each of the three light beams having different wavelengths for a CD, for a DVD and for a BD. The detail of the structure of the diffraction grating provided to the diffraction element 11 will be described later. The light beam that passed through the diffraction element 11 is sent to the objective lens 12.

The objective lens 12 condenses the light beam that passed through the diffraction element 11 on the recording surface 15a of the optical recording medium 15. In addition, the objective lens 12 is driven by an objective lens driving unit (not shown) and can move in the vertical direction and the horizontal direction in FIG. 1. A position of the objective lens 12 is controlled based on a focus servo signal and a tracking servo signal. At this point the aperture limiting filter 10 and the diffraction element 11 are also mounted on the objective lens driving unit so that they can move together with the objective lens 12 in the present embodiment. However, it is not always necessary to mount the aperture limiting filter 10 and the diffraction element 11 on the objective lens driving unit, and its structure can be modified in accordance with a structure of the optical system.

The reflection light reflected by the optical recording medium 15 passes through the objective lens 12, the diffraction element 11 and the aperture limiting filter 10 in this order and is reflected by the upstand mirror 9. After that, the reflection light is further reflected by the beam splitter 8 and is condensed by the detection lens 13 on a light receiving area (not shown) of the photo detector 14.

The photo detector 14 is provided with light receiving areas (not shown) for receiving 0 order light and ±1st order light that are generated when the reflection light reflected by the optical recording medium 15 passes through the diffraction element 11. The light information received by the light receiving area is converted into an electric signal, which is outputted to an RF amplifier (not shown) or the like. In this case, the 0 order light received by the photo detector 14 is used as a signal for recording and reproducing information, while the ±1st order light is used as a signal for the servo control. In the present embodiment, the focus servo signal is obtained from the +1st order light by using a spot size method, and the tracking servo signal is obtained from the −1st order light by using a correct far-field method. However, the method of generating the signal for the servo control is not limited to the structure of the present embodiment but can be modified variously in accordance with the purpose.

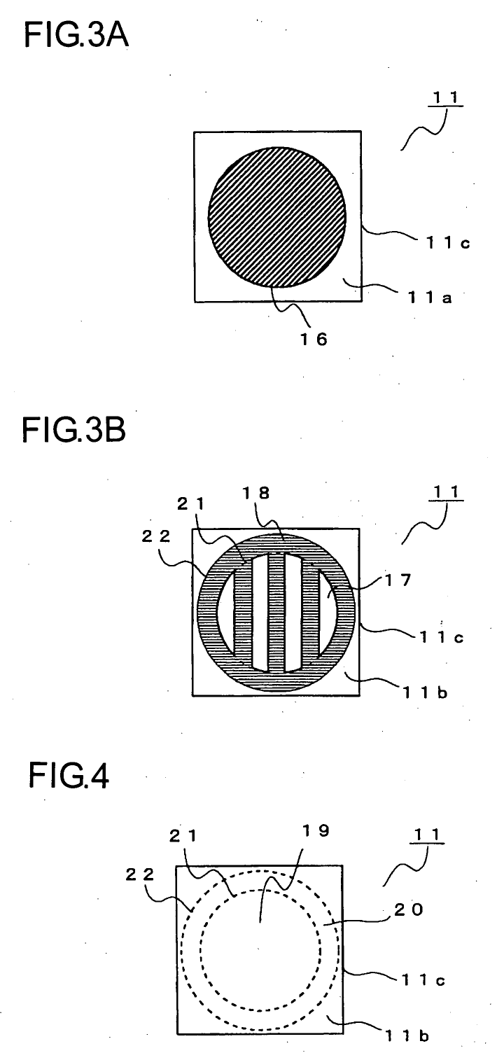

Next, detail of the structure of the diffraction grating provided to the diffraction element 11 will be described. FIGS. 3A and 3B are plan views to show schematically the structure of the surface of the diffraction element 11 on which the diffraction grating is disposed according to the present embodiment. FIG. 3A is a diagram of the surface 11a shown in FIG. 1, and FIG. 3B is a diagram of the surface 11b shown in FIG. 1. As shown in FIG. 3A, the surface 11a of the transparent substrate 11c is provided with a diffraction area 16 made up of one type of diffraction grating. This diffraction area 16 generates predetermined diffracted light only from the light beam for a DVD emitted from the second light source 3 (see FIG. 1) and permits other light beams emitted from the light sources 2 and 4 (see FIG. 1) to pass through without generating diffracted light. Hereinafter, the diffraction area 16 may be referred to as a DVD diffraction area 16.

The diffraction area 16 is formed to have a circular shape as shown in FIG. 3A, and the diameter of this circle is set to be substantially the same as an incident diameter of the light beam for a DVD that enters the diffraction element 11. At this point the structure of the diffraction area 16 is not limited to the circular shape of the present embodiment. For example, it is possible to adopt a structure in which the diffraction area 16 is formed on the entire area of the surface 11a. In this case, an advantage of easy adjustment may be obtained when the diffraction element 11 is disposed in the optical system of the optical pickup device 1.

As shown in FIG. 3B, the surface 11b of the transparent substrate 11c is provided with two types of diffraction areas 17 (white areas) and 18 (an area hatched with horizontal lines). The diffraction area 17 generates predetermined diffracted light only from the light beam for a CD emitted from the first light source 2 and permits other light beams emitted from the light sources 3 and 4 to pass through without generating diffracted light. In addition, the diffraction area 18 generates predetermined diffracted light only from the light beam for a BD emitted from the third light source 4 and permits other light beams emitted from the light sources 2 and 3. Hereinafter, the diffraction area 17 may be referred to as a CD diffraction area 17, and the diffraction area 18 may be referred to as a BD diffraction area 18.

The diffraction areas 17 and 18 formed on the surface 11b of the diffraction element 11 are arranged in a first region and a second region within the surface 11b. The first region and the second region will be described with reference to FIG. 4. FIG. 4 is an explanatory diagram for explaining first and the second regions 19 and 20. In FIG. 4, a first circle 21 has substantially the same diameter as the light beam that is emitted from the first light source 2 for emitting the light beam for a CD and enters the diffraction element 11 after its beam diameter is restricted by the aperture limiting filter 10 (see FIG. 1). A second circle 22 has substantially the same diameter as the light beam that is emitted from the third light source 4 for emitting the light beam for a BD and enters the diffraction element 11 after its beam diameter is restricted by the aperture limiting filter 10. At this point centers of the first circle 21 and the second circle 22 agree substantially with each other and further agree substantially with the center of the circle that defines the diffraction area 16 (see FIG. 3A).

Furthermore, the first region 19 is a region defined by the first circle 21, and the second region 20 is a region between the first circle 21 and the second circle 22. At this point the first region 19 and the second region 20 are not limited to the inside region of the circle and the annular region but can be modified variously within the scope of the present invention. For example, it is possible to define the second region 20 as the region on the surface 11b except for the first region 19 that is defined by the first circle 21. In this case, an advantage of easy adjustment may be obtained when the diffraction element 11 is disposed in the optical system of the optical pickup device 1. In addition, although the first region 19 and the second region 20 are both defined as regions enclosed by the circles, it is possible to define them as regions enclosed by rectangles.

As understood from reference to FIGS. 3B and 4, two types of diffraction areas 17 and 18 are arranged in the first region 19 and are divided into a plurality of parts. The plurality of divided parts are arranged so that the diffraction area 17 and the diffraction area 18 are placed alternately and repeatedly in a stripe manner. In addition, only the diffraction area 18 is disposed in the second region 20. Furthermore, this diffraction element 11 is arranged in the optical system of the optical pickup device 1 so that the center of the first circle 21 agrees substantially with the optical axis of the light beam that passes through the diffraction element 11.

This structure of the diffraction element 11 can avoid a wasteful arrangement of the CD diffraction area 17 unlike the conventional structure in which the CD diffraction area 17 is arranged also in the second region 20 (see FIG. 4) through which the light beam for a CD does not pass through. Therefore, this region 20 can be used effectively for obtaining diffracted light from the light beam for a BD. Furthermore, in the first region 19 where the CD diffraction area 17 and the BD diffraction area 18 are arranged, the CD diffraction area 17 can be arranged a little more because the diffracted light from the light beam for a BD can be generated in the second region 20 to some extent of light quantity. Therefore, the diffraction element 11 can increase the usage efficiency of light compared with a conventional diffraction element.

Although each of the diffraction areas 17 and 18 arranged in the first region 19 is divided into a plurality of parts, which are arranged in a stripe manner so that the diffraction area 17 and the diffraction area 18 are repeated alternately in the present embodiment, the present invention is not limited to this structure. The structure can be modified variously within the scope of the present invention. For example, it is possible to adopt a structure in which the diffraction areas 17 and 18 are divided into a plurality of concentric parts that are arranged alternately. However, the arrangement of the present embodiment is more preferable because that light beam entering the diffraction element 11 can be distributed equally to the diffraction areas 17 and 18.

In addition, although one type of diffraction area 16 is disposed on the surface 11a while two types of diffraction areas 17 and 18 are disposed on the surface 11b in the present embodiment, it is possible to adopt the opposite structure in which two types of diffraction areas are disposed on the surface 11a while one type of diffraction area is disposed on the surface 11b.

In addition, although the DVD diffraction area 16 is formed on the surface 11a while the CD diffraction area 17 and the BD diffraction area 18 are formed on the surface 11b in the present embodiment, the present invention is not limited to this structure but can adopt other various modified structures without deviating from the object of the present invention. For example, it is possible to adopt a structure in which the BD diffraction area 18 is formed on the surface 11a while the CD diffraction area 17 and the BD diffraction area 18 are formed on the surface 11b. However, the structure of the present embodiment, in which the two types of diffraction areas are formed on the surface 11b in a combination such that a difference of incident diameter between light beams entering the diffraction element 11 becomes large, has an advantage that the usage efficiency of light can be improved easily.

Although the optical pickup device 1 of the present embodiment described above has the structure for supporting three types of optical recording media including a CD, a DVD and a BD, the present invention is not limited to this structure but can adopt other structures modified variously without deviating from the object of the present invention. For example, it is possible to adopt a combination other than the combination of optical recording media shown in the present embodiment. In addition, it is possible that the optical pickup device supports not three types of optical recording media but four or more types of optical recording media. In the case where four types of optical recording media are supported for example, two types of diffraction areas may be formed on each surface of the transparent substrate 11c (see FIG. 3) of the diffraction element. Alternately, one type of diffraction area may be formed on one surface while three types of diffraction areas are formed on the other surface.

If three types of diffraction areas are formed on one surface for example, the following structure may be adopted. Only the diffraction area that generates predetermined diffracted light from the light beam having the largest diameter that enters the diffraction element 11 among light beams that generate predetermined diffracted light in the three types of diffraction areas is disposed in the second region 20 (see FIG. 4). On the first region 19 (see FIG. 4); three types of diffraction areas are arranged so that different types of diffraction areas are arranged to neighbor each other and are repeated in a predetermined order. It is also possible that the first region 19 is further divided into two regions that are a circular region and an annular region in the same manner as the first region 19 and the second region 20 of the present embodiment.

Furthermore, although the diffraction element 11 is provided for obtaining the focus servo signal and the tracking servo signal in the optical pickup device 1 of the present embodiment, the optical pickup device of the present invention is not limited to this structure. For example, it is possible that the optical pickup device has a structure in which the diffraction element is disposed for obtaining only the tracking servo signal.

The present invention can be applied to an optical pickup device that can support a plurality of types of optical recording media and can obtain predetermined diffracted light from a plurality of light beams having different wavelengths by a single diffraction element. In such an optical pickup device, a structure of the diffraction element is devised so that usage efficiency of light in a diffraction element is improved. Therefore, the optical pickup device that can support a plurality of optical recording media can be downsized while it can maintain quality of recording and reproducing information.

What is claimed is:

1. An optical pickup device comprising:
a plurality of light sources having different wavelengths;
a condenser element for condensing a light beam emitted from the light source on a recording surface of the optical recording medium;
a diffraction element disposed between the light source and the condenser element for diffracting an incident light beam, the diffraction element including a transparent substrate having two opposed surfaces and a diffraction grating formed on at least one of the two surfaces, wherein
the light beams entering the diffraction element have different incident diameters for different wavelengths, at least one of the two surfaces is provided with a first region and a second region,
the second region is arranged to enclose the first region,
the surface with the first and the second regions is provided with a plurality of types of diffraction areas each of which generates predetermined diffracted light from only the light beam having a specific wavelength and permits other light beams having other wavelengths to pass through without diffraction,
each of the plurality of types of diffraction areas is disposed in the first region, and
only a diffraction area that generates the predetermined diffracted light from the light beam having the maximum incident diameter among the plurality of types of diffraction areas is disposed in the second region.

2. The optical pickup device according to claim 1, wherein
the first region is an region enclosed by a first circle having a diameter that is substantially the same as a diameter of a light beam other than the light beam having the maximum incident diameter among light beams that generate the predetermined diffracted light in the diffraction area, and
the second region is an region enclosing the first circle and including a second circle substantially concentric with the first circle and the second circle having a diameter that is substantially the same as a diameter of a light beam having the maximum incident diameter among light beams that generate the predetermined diffracted light in the diffraction area.

3. The optical pickup device according to claim 1, wherein the plurality of types of diffraction areas include two types of diffraction areas, and in the first region each of the two types of diffraction areas is divided into a plurality of parts, which are arranged in a stripe manner so that different types of the diffraction areas are repeated alternately.

4. The optical pickup device according to claim 2, wherein the plurality of types of diffraction areas include two types of diffraction areas, and in the first region each of the two types of diffraction areas is divided into a plurality of parts, which are arranged in a stripe manner so that different types of the diffraction areas are repeated alternately.

5. The optical pickup device according to claim 1, wherein
the light sources include three light sources, the plurality of diffraction areas include two types of diffraction areas, and
one of the two types of diffraction areas generates the predetermined diffracted light from only the light beam having the maximum incident diameter among light beams emitted from the light sources, while the other generates the predetermined diffracted light from only the light beam having the minimum incident diameter among light beams emitted from the light sources.

6. The optical pickup device according to claim 2, wherein
the light sources include three light sources,
the plurality of diffraction areas include two types of diffraction areas, and
one of the two types of diffraction areas generates the predetermined diffracted light from only the light beam having the maximum incident diameter among light beams emitted from the light sources, while the other generates the predetermined diffracted light from only the light beam having the minimum incident diameter among light beams emitted from the light sources.

7. The optical pickup device according to claim 3, wherein
the light sources include three light sources,
the plurality of diffraction areas include two types of diffraction areas, and
one of the two types of diffraction areas generates the predetermined diffracted light from only the light beam having the maximum incident diameter among light beams emitted from the light sources, while the other generates the predetermined diffracted light from only the light beam having the minimum incident diameter among light beams emitted from the light sources.

8. The optical pickup device according to claim 4, wherein
the light sources include three light sources,
the plurality of diffraction areas include two types of diffraction areas, and
one of the two types of diffraction areas generates the predetermined diffracted light from only the light beam having the maximum incident diameter among light beams emitted from the light sources, while the other generates the predetermined diffracted light from only the light beam having the minimum incident diameter among light beams emitted from the light sources.

9. An optical pickup device comprising:
three light sources having different wavelengths;
a condenser element for condensing a light beam emitted from the light source on a recording surface of the optical recording medium;
a diffraction element disposed between the light source and the condenser element for diffracting an incident light beam, the diffraction element including a transparent substrate having two opposed surfaces and a diffraction grating formed on at least one of the two surfaces, wherein
when the three light beams having different wavelengths emitted from the light sources are a first light beam, a second light beam and a third light beam in ascending order of an incident diameter entering the diffraction element from smaller one, one of the two surfaces is provided with a second diffraction area that generates predetermined diffracted light from only the second light beam and permits the first and the third light beams to pass through without diffraction,
the other of the two surfaces is provided with a first region and a second region,
the first region is an region enclosed by a first circle having a diameter that is substantially the same as the incident diameter of the first light beam, and the first region is provided with a first diffraction area that generates predetermined diffracted light from only the first light beam and permits the second and the third light beams to pass through without diffraction and a third diffraction area that generates predetermined diffracted light from only the third light beam and permits the first and the second light beams to pass through without diffraction, each of which is divided into a plurality of parts that are arranged in a stripe manner so that the first diffraction area and the third diffraction area repeat alternately, and
the second region is an region enclosing the first circle and including a second circle substantially concentric with the first circle and the second circle having a diameter that is substantially the same as the incident diameter of the third light beam, and the second region is provided with only the third diffraction area.
